(19) United States
(12) Patent Application Publication
(10) Pub. No.: US 2008/0280230 A1
(43) Pub. Date: Nov. 13, 2008

(54) PHOTOLITHOGRAPHY PROCESS INCLUDING A CHEMICAL RINSE

(75) Inventors: Ching-Yu Chang, Yilang County (TW); Chin-Hsiang Lin, Hsin-Chu (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/747,124

(22) Filed: May 10, 2007

(51) Int. Cl. G03C 5/00

(52) U.S. Cl. 430/312

(57) ABSTRACT

The present disclosure provides a plurality of methods of performing a lithography process. In one embodiment, a substrate including a layer of photoresist is provided. The layer of photoresist is exposed. The exposed layer of photoresist is developed. A chemical rinse solution is applied to the developed photoresist. The chemical rinse solution includes an alcohol base chemical. The substrate is spun dry.

### BACKGROUND

The present disclosure relates generally to photolithography, such as is used in the fabrication of semiconductor integrated circuits.

Photolithography is a mechanism by which a pattern on a mask is projected onto a substrate such as a semiconductor wafer. Semiconductor photolithography typically includes the process steps of applying a layer of photoresist on a top surface of a semiconductor substrate and exposing the photoresist to a pattern. A post-exposure bake (PEB) is often performed to allow the exposed photoresist polymers to cleave. The substrate including the cleaved polymer photoresist is then transferred to a developing chamber to remove the exposed photoresist, which is soluble to an aqueous developer solution. Typically, a developer solution such as tetra-methyl ammonium hydroxide (TMAH) is applied to the resist surface in the form of a puddle to develop the exposed photoresist. A de-ionized (DI) water rinse is then applied to the substrate to remove the dissolved polymers of the photoresist. The substrate is then sent to a spin dry process. The substrate may then be transferred to the next process, which may include a hard bake process to remove any moisture from the photoresist surface.

This conventional process however has a plurality of problems. As technologies advance and dimension requirements tighten, photoresist patterns are required to include relatively thin and tall features of photoresist on the substrate. The features may suffer from bending and/or collapsing during the photolithography process, and in particular during the spin dry process, due to excessive capillary forces of DI water that is disposed between adjacent photoresist features, the DI water remaining on the substrate from the DI water rinse included in the lithography process. One solution to this issue includes adding supercritical CO₂ to reduce the surface tension by reducing the hydrogen bonding. However, this solution may add significant cost to the process. Another solution for immersion lithography may include using a photoresist with modified polymers to make it more hydrophobic. However, this solution may decrease the wettability of the developing solution. Another problem of the conventional lithography process is line edge roughness (LER) due to resist and optical resolution limits. LER includes horizontal and vertical deviations from a feature's ideal form. Especially as critical dimensions shrink, the LER becomes more problematic and may cause yield loss. An additional problem of the conventional photolithography process is the presence of watermark defects. Watermarks may form on the photoresist as the DI water from the DI water rinse can not be spun off on the hydrophobic surface of the photoresist. The photoresist may be hydrophobic particularly in areas of isolated, or non-dense, patterning. The watermarks may have a harmful effect on yield and device performance.

As such, an improved method for performing a photolithography process is desired.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating an embodiment of a method for performing a lithography process.

FIGS. 2a, 2b, 2c, 2d, 2e, and 2f are cross sectional views illustrating a semiconductor substrate that is being processed according to an embodiment of the method of FIG. 1.

FIG. 3 is a flowchart illustrating an embodiment of a method for performing a lithography process.

FIGS. 4a, 4b, and 4c are cross sectional views illustrating a semiconductor substrate that is being processed according to an embodiment of the method of FIG. 3.

### DETAILED DESCRIPTION

The present disclosure relates generally to the fabrication of semiconductor devices, and more particularly, to a method of photolithography including a chemical rinse. It is understood, however, that specific embodiments are provided as examples to teach the broader inventive concept, and one of ordinary skill in the art can easily apply the teaching of the present disclosure to other methods or apparatus. Also, it is understood that the methods and apparatus discussed in the present disclosure include some conventional structures and/or processes. Since these structures and processes are well known in the art, they will only be discussed in a general level of detail. Furthermore, reference numbers are repeated throughout the drawings for sake of convenience and example, and such repetition does not indicate any required combination of features or steps throughout the drawings.

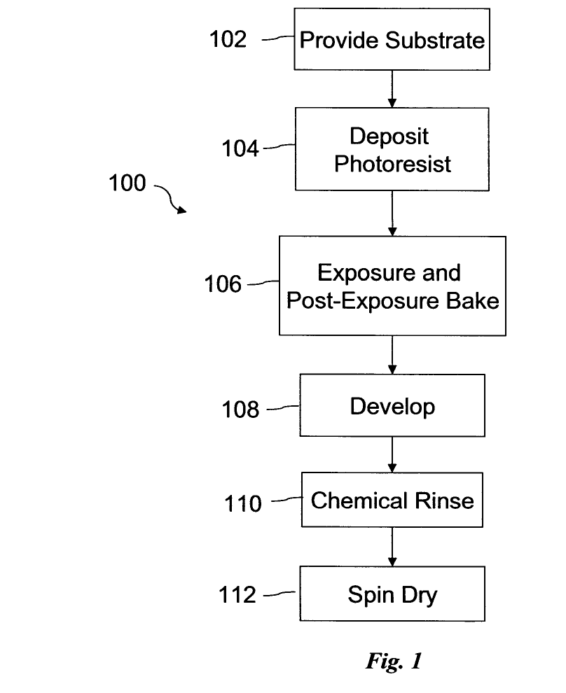

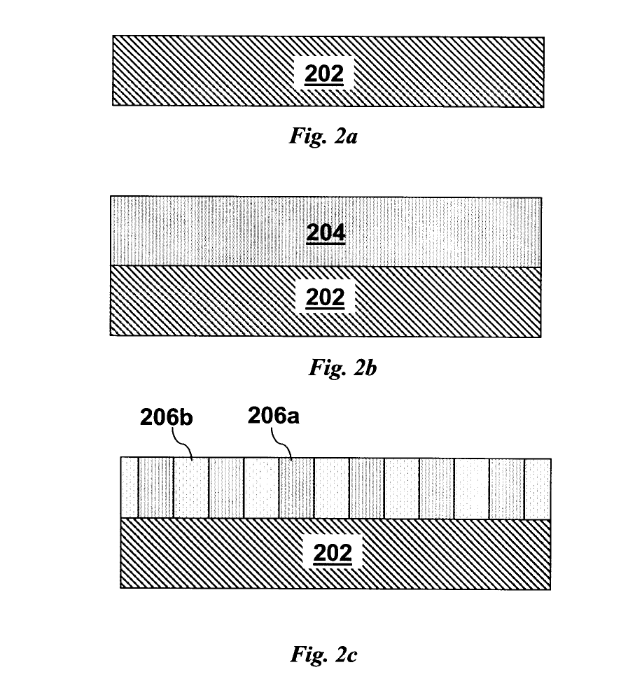

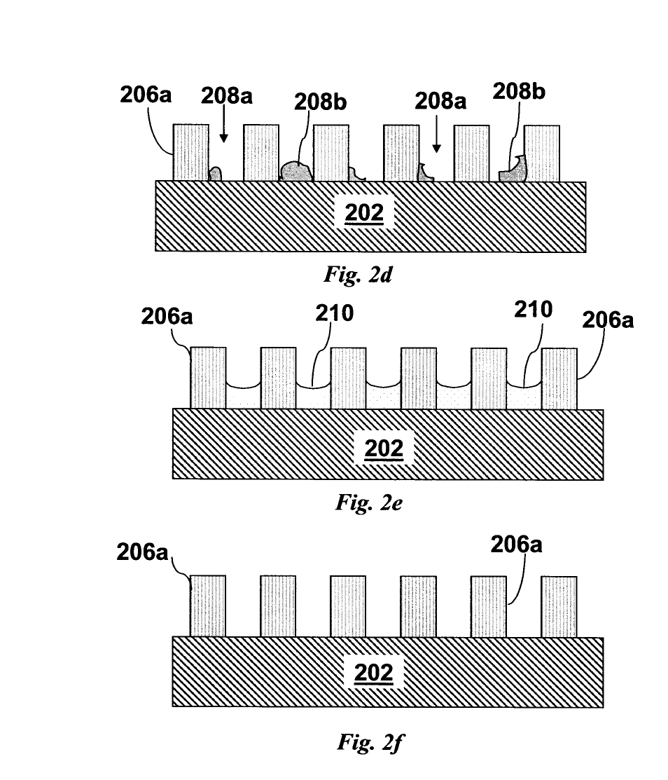

FIG. 1 illustrates an embodiment of a method 100 for performing a photolithography process implementing the teachings of this disclosure, and FIGS. 2a, 2b, 2c, 2d, 2e, and 2f show incremental modifications of a semiconductor substrate 102a that correspond to the steps illustrated in FIG. 1.

The method 100 begins at step 102 where a substrate is provided. For the sake of example, processing a substrate in the form of a semiconductor wafer may be described. It is to be understood however, that other examples of substrates and processes may benefit from the present invention such as, for example, printed circuit board substrates, damascene processes, and thin film transistor liquid crystal display (TFT-LCD) substrates and processes. Referring to the example of FIG. 2a, a substrate 202 is provided.

The method 100 proceeds to step 104 where photoresist is deposited on the substrate. Referring to the example of FIG. 2b, the substrate 202 receives a layer of photoresist 204. The substrate 202 may include a plurality of films, such as a thin-film stack. The photoresist 204 may include a conventional photoresist and may be deposited using conventional methods, such as spin-on coating. In an embodiment, the photoresist 204 includes commercially available 193 nm resist.

At step 106, an exposure operation and a post exposure bake (PEB) may be performed. Referring to the example of FIG. 2c, the photoresist 204 is patterned to include portions of exposed photoresist 206b and portions of unexposed photoresist 206a. It is to be understood that a variety of photoresist types known in the art may be utilized, for the sake of example, a positive photoresist is illustrated. The exposure system and the bake system may be separate systems.

The method 100 proceeds to step 108 where a development process is performed on the substrate including the patterned photoresist. The development process may include applying an aqueous tetra-methyl ammonium hydroxide (TMAH) solution to the substrate. TMAH may be applied using a puddle process. The development process may remove the soluble portions of the photoresist. Referring to the examples of FIGS. 2c and 2d, the removal of the soluble photoresist, the exposed photoresist 206b, creates gaps 208a, thereby creating the mask pattern on the substrate 202. After the development process, polymers of the dissolved resist may still be present on the substrate 202, such as is illustrated by residue particles 208b of FIG. 2d. In an embodiment, after the development process of step 108 the substrate is rinsed with DI water. Referring to the example of FIG. 2d, if applied, the DI water rinse rinses the substrate 202 and removes a portion of the residue particles 108b. A portion of the residue particles 108b may remain on the substrate 202 and be removed in further steps as illustrated below.

The method 100 then proceeds to step 110 where a chemical rinse is performed. The chemical rinse includes rinsing the substrate with a chemical rinse solution that may include an alcohol base chemical. In an embodiment, the chemical rinse solution includes greater than approximately 0.1% alcohol base chemical by weight. The chemical rinse solution may have a surface tension less than that of pure water (e.g. pure water surface tension may be 72 dynes/cm at 25° C., the chemical rinse solution surface tension may be less than 72 dynes/cm at 25° C.). The alcohol base chemical may include isobutyl alcohol (IBA). In an embodiment, the chemical rinse solution includes between approximately 5% and 10% IBA by weight. IBA may be an advantageous alcohol base chemical because, for example, it is cost effective. In an alternative embodiment, the alcohol base chemical may include a variety of other alcohol solvents such as, for example, ethanol, methanol, isopropyl alcohol (IPA), acetone, butanol, tert-butanol, cyclohexanol, 2-methyl-2-butanol, isopentyl alcohol, cyclohexanol, and/or xylene. In an embodiment, the chemical rinse solution includes IBA and one or more additional alcohol solvents such as, for example, methanol, ethanol, isopropyl alcohol (IPA), acetone, butanol, tert-butanol, cyclohexanol, 2-methyl-2-butanol, isopentyl alcohol, cyclohexanol, and/or xylene. In an embodiment, the chemical rinse solution includes IBA and approximately 9.5% of an additional alcohol solvent such as, for example, methanol, ethanol, isopropyl alcohol (IPA), acetone, butanol, tert-butanol, cyclohexanol, 2-methyl-2-butanol, isopentyl alcohol, cyclohexanol, and/or xylene. The chemical rinse solution may include a chemical additive in addition to the alcohol base chemical. In an embodiment, the chemical additive is a surfactant.

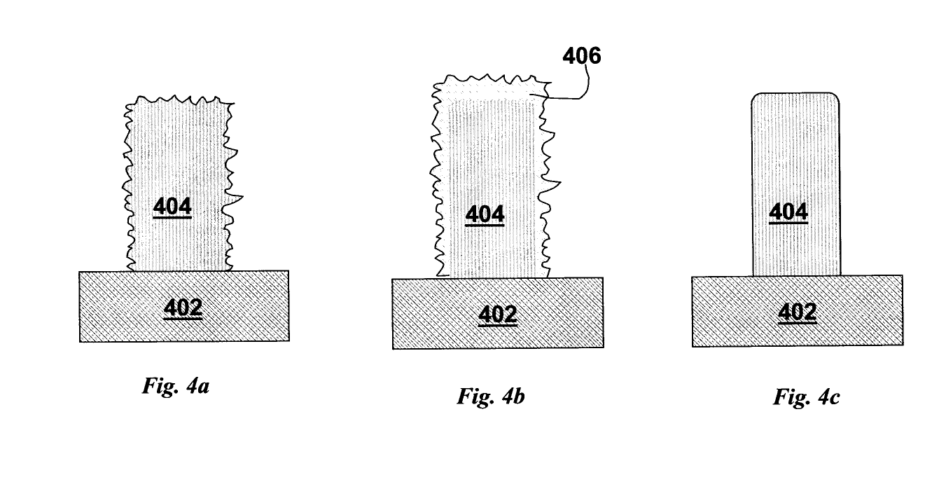

Referring to the example of FIG. 2e, a chemical rinse solution 210 is introduced to the substrate 202. In an embodiment, the chemical rinse solution 210 is dynamically dispensed onto the substrate 202. In an alternative embodiment, the chemical rinse solution 210 is puddled on the substrate 202. The residue particles 208b, illustrated in FIG. 2d, may be miscible in the chemical rinse solution 210. The chemical rinse solution 210 may remove the residue particles 208b from the substrate 202. In an embodiment, the chemical rinse solution 210 and a DI water rinse remove the residue particles 208b from the substrate 202. The chemical rinse solution 210 may provide improved LER for the features of the photoresist 206a as described below with reference to FIGS. 4a, 4b, and 4c. The chemical rinse solution 210 may provide for reduced watermarks, as the exposed surface of the substrate 202 and photoresist 206a may be hydrophilic after treatment with the chemical rinse solution 210. This, for example, may allow water, such as water present from a DI water rinse, to diffuse into hydrophilic surface of the photoresist 206a, thus not be disposed on the surface creating watermarks.

The placement of the chemical rinse of step 110 in the method 100 is illustrative only. The chemical rinse may occur at different steps in the method 100 and/or may occur at multiple steps. In an embodiment, a chemical rinse solution is applied after the PEB of step 106 and before the develop process of step 108. In an embodiment, a first chemical rinse solution is applied after the PEB of step 106 and before the developing process of step 108, and a second chemical rinse solution is applied after the developing process. In an embodiment, a chemical rinse solution is applied substantially simultaneously with the developer solution. In an embodiment, a DI water rinse is included in the method 100 after the developing process of step 108 and before the spin dry process of step 112. A chemical rinse may occur before and/or after the DI water rinse. In each of these illustrated embodiments of the method 100, the chemical rinse solution may be substantially similar to the chemical rinse solution described above with reference to step 110.

From step 110, the method 100 proceeds to step 112 where a spin dry process is performed on the substrate. Referring to the example of FIGS. 2e and 2f, the chemical rinse solution 210 may be present on the substrate 202 prior to the spin dry process, and may be substantially removed by the spin dry process. In an embodiment, DI water from a DI water rinse included in the lithography process is also be present on the substrate 202 and is substantially removed by the spin dry process. The chemical rinse solution 210 may have lower surface tension than pure DI water which may be present on the substrate prior to the spin dry in a conventional lithography process. The chemical rinse solution 210 may allow for lower capillary forces on the features of photoresist 206a during the spin dry step. This may allow for lower incidents of defects, such as the collapsing or bending of the features of photoresist 206a. The substrate 202 then proceeds to further processing which may include a hard bake step, plasma etching, wet etching, and/or ion implantation, prior to removing the photoresist 206a from the substrate 202.

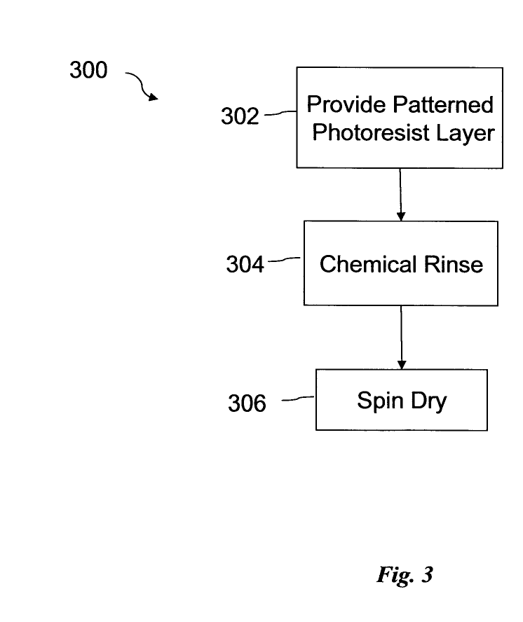

Referring now to FIG. 3, a method 300 of an alternative embodiment of a lithography process including a chemical rinse is illustrated. The method 300 begins at step 302 where a patterned photoresist layer included on a substrate is provided. A patterned layer of photoresist includes any layer of photoresist that has been exposed, such as by the exposure of step 106 of FIG. 1 (the patterned layer of photoresist may or may not have been processed through the PEB), prior to the removal, or stripping, of the photoresist layer. For example, the patterned layer of photoresist provided may have been exposed, developed, rinsed, DI water rinsed, chemical rinsed, and/or spin-dried. The patterned layer of photoresist provided may have been hard baked. The patterned photoresist layer provided may have completed after development inspection (ADI). The patterned photoresist layer may have been fabricated using the method 100 described above with reference to FIG. 1.

The method 300 continues to step 304 where a chemical rinse is provided. The chemical rinse includes rinsing the patterned photoresist layer with a chemical rinse solution that includes an alcohol base chemical. In an embodiment, the chemical rinse solution includes greater than approximately 0.1% alcohol base chemical by weight. The chemical rinse solution may have a surface tension less than that of pure water (e.g. pure water surface tension may be 72 dynes/cm at 25° C., the chemical rinse solution surface tension may be less than 72 dynes/cm at 25° C.). The alcohol base chemical may include isobutyl alcohol (IBA). In an embodiment, the chemical rinse solution includes between approximately 5% and 10% IBA by weight. IBA may be an advantageous alcohol base chemical because, for example, it is cost effective. In an alternative embodiment, the alcohol base chemical may include a variety of other alcohol solvents such as, for example, ethanol, methanol, isopropyl alcohol (IPA), acetone, butanol, tert-butanol, cyclohexanol, 2-methyl-2-butanol, isopentyl alcohol, cyclohexanol, and/or xylene. In an embodiment, the chemical rinse solution includes IBA and one or more additional alcohol solvents such as, for example, isopropyl alcohol (IPA), acetone, butanol, tert-butanol, cyclohexanol, 2-methyl-2-butanol, isopentyl alcohol, cyclohexanol, and/or xylene. In an embodiment, the chemical rinse solution includes IBA and approximately 9.5% of an additional alcohol solvent such as, for example, methanol, isopropyl alcohol (IPA), acetone, butanol, tert-butanol, cyclohexanol, 2-methyl-2-butanol, isopentyl alcohol, cyclohexanol, and/or xylene. The chemical rinse solution may include a chemical additive in addition to the alcohol base chemical. In an embodiment, the chemical additive is a surfactant. The surfactant may selected from surfactants such as, 3M Novec fluid HFE-7000, HFE-7100, HFE-7200, HFE-7500, HFE-711PA. 3M Fluorinert FC-72, FC-84, FC-77, FC-3255, FC-3283, FC-40, FC-43, FC-70. 3M Novec 4200, 3M Novec 4300, 3M FC-4432. 3M FC-4430, 3M FC-4434 and/or other surfactants known in the art. The chemical rinse solution may be puddled on the patterned photoresist layer. In an embodiment, the puddle time is between approximately 1 second and 100 seconds. In an alternative embodiment, the chemical rinse is dynamically dispensed onto the patterned photoresist layer.

The method 300 then continues to step 306 where a spin dry process is performed on the substrate including the patterned photoresist layer. In an embodiment of the method 300, a DI water rinse follows the chemical rinse of step 304 prior to the spin dry process of step 306. An advantage of the method 300 may include improving the LER of a feature of the patterned photoresist layer. In an embodiment, the method 300 may be used to improve the LER of a feature of a patterned photoresist layer identified at ADI prior to forming an IC feature on the substrate such as, for example, performing a plasma etch to form a gate or conductive line, or ion implantation to form a source/drain.

Referring now to FIGS. 4a, 4b, and 4c, a substrate 402 including a patterned photoresist layer 404 is illustrated, specifically one feature of the patterned photoresist layer 404 is illustrated. The substrate 402 may be similar to the substrate 202 described above with reference to FIGS. 2a, 2b, 2c, 2d, 2e, and 2f. The patterned photoresist layer 404 may be similar to and formed in a similar manner as the photoresist 206a, described above with reference to FIGS. 2a, 2b, 2c, 2d, 2e, and 2f. The patterned photoresist layer 404 includes line edge roughness. In the embodiment, in step 304, a chemical rinse is provided. The chemical rinse includes applying a chemical rinse solution 406, the chemical rinse solution 406 includes an alcohol base chemical, as described above with reference to FIG. 3. The chemical rinse solution 406 may surround the features of the patterned photoresist layer 404, as illustrated in FIG. 4b. The chemical rinse solution 406 may dissolve the polymer of the patterned photoresist layer 404 and/or provide physical surface stress on the patterned photoresist layer 404. Thus, the chemical rinse solution 406 may provide smoothing of the surface of the patterned photoresist layer 404 decreases its LER. The method 300 then continues to step 306 where, in the illustrated embodiment, the patterned photoresist layer 404 and the substrate 402 are spun dry. The patterned photoresist layer 404 may then include improved LER as illustrated by FIG. 4c.

Although only a few exemplary embodiments of this invention have been described in detail above, those skilled in the art will readily appreciate that many modifications are possible in the exemplary embodiments without materially departing from the novel teachings and advantages of this disclosure.

Thus the present disclosure provides in one embodiment, a method of performing a lithography process. The method includes providing a substrate including a layer of photoresist. The layer of photoresist is exposed and developed. A chemical rinse solution is applied to the developed photoresist. The chemical rinse solution includes an alcohol base chemical. A spin dry process is performed after the application of the chemical rinse solution. The chemical rinse solution may have a lower surface tension than that of pure water. In one embodiment, the alcohol base chemical is isobutyl alcohol.

In another embodiment, a method of performing a lithography process is provided. The method includes providing a substrate including a photoresist layer. The photoresist layer is exposed. A chemical rinse solution is applied to the exposed photoresist layer. The chemical rinse solution includes an alcohol base chemical. The exposed photoresist layer is developed, and the substrate including the developed photoresist layer is spun dry. In one embodiment, the alcohol base chemical is isobutyl alcohol. In one embodiment, a chemical rinse solution including an alcohol base chemical is also applied to the developed photoresist layer.

In another embodiment, a method of performing a lithography process including providing a substrate including a patterned photoresist layer. An alcohol base chemical is applied to the patterned photoresist layer. The substrate is spun dry after the application of the alcohol base chemical. In one embodiment, the alcohol base chemical is isobutyl alcohol.

What is claimed is:

1. A method of performing a lithography process, comprising:
providing a substrate including a layer of photoresist;
exposing the layer of photoresist;
developing the exposed layer of photoresist;
applying a chemical rinse solution to the developed layer of photoresist, wherein the chemical rinse solution includes an alcohol base chemical; and
spin drying the substrate after the application of the chemical rinse solution.

2. The method of claim 1, wherein the alcohol base chemical includes isobutyl alcohol.

3. The method of claim 2, wherein the chemical rinse solution includes between approximately 5% and 10% isobutyl alcohol by weight.

4. The method of claim 2, wherein the chemical rinse solution further comprises a chemical selected from the group consisting of ethanol, isopropyl alcohol, acetone, butanol, tert-butanol, cyclohexanol, 2-methyl-2-butanol, isopentyl alcohol, cyclohexanol, and xylene.

5. The method of claim 1, wherein the alcohol base chemical is selected from the group consisting of ethanol, isopropyl alcohol, acetone, butanol, tert-butanol, cyclohexanol, 2-methyl-2-butanol, cyclohexanol, and isopentyl alcohol.

6. The method claim 1, wherein the chemical rinse solution includes a surfactant.

7. The method of claim 1, further comprising:
rinsing the developed layer of photoresist with DI water.

8. The method of claim 1, wherein the chemical rinse solution includes a lower surface tension than pure water.

9. The method of claim 1, wherein the chemical rinse solution includes water and at least 0.1% alcohol base chemical by weight.

10. A method of performing a lithography process, comprising:
providing a substrate including a photoresist layer;
exposing the photoresist layer;
applying a first chemical rinse solution to the exposed photoresist layer, wherein the first chemical rinse solution includes an alcohol base chemical;
developing the exposed photoresist layer; and
spin drying the substrate including the developed photoresist layer.

11. The method of claim 10, wherein the alcohol base chemical includes isobutyl alcohol.

12. The method of claim 11, wherein the chemical rinse solution includes between approximately 5% and 10% isobutyl alcohol by weight.

13. The method of claim 10, wherein the alcohol base chemical is selected from the group consisting of ethanol, isobutyl alcohol, isopropyl alcohol, acetone, butanol, tert-butanol, cyclohexanol, 2-methyl-2-butanol, cyclohexanol, and isopentyl alcohol.

14. The method of claim 10, further comprising:
rinsing the developed photoresist layer with DI water.

15. The method of claim 10, further comprising:
applying a second chemical rinse solution to the developed photoresist layer, wherein the second chemical rinse solution includes an alcohol base chemical.

16. A method of semiconductor manufacturing, comprising:
providing a substrate including a patterned photoresist layer;
applying an alcohol base chemical to the patterned photoresist layer; and
spin drying the substrate after the application of the alcohol base chemical to the patterned photoresist layer.

17. The method of claim 16, wherein the applying the alcohol base chemical includes
puddling the alcohol base chemical on the patterned photoresist layer.

18. The method of claim 16, wherein the alcohol base chemical includes isobutyl alcohol.

19. The method of claim 16, further comprising:
applying a DI water rinse to the patterned photoresist layer.

20. The method of claim 16, wherein the provided patterned photoresist layer has completed an after development inspection.
